(19) United States
(12) Patent Application Publication
(10) Pub. No.: US 2024/0254701 A1
(43) Pub. Date: Aug. 1, 2024

(54) Self-rotating Asphalt Emulsification Mixing Production Apparatus

(71) Applicant: Central South University of Forestry and Technology, Changsha (CN)

(72) Inventors: Kefei LIU, Changsha (CN); Kang JIANG, Changsha (CN); Yongqiang LI, Changsha (CN); Quan LI, Changsha (CN)

(21) Appl. No.: 18/543,055

(22) Filed: Dec. 18, 2023

(30) Foreign Application Priority Data
Feb. 1, 2023 (CN) 202310050017.7

(51) Int. Cl. E01C 19/10; B01F 27/09; B01F 27/115; B01F 27/171; B01F 27/2124; B01F 29/80; B01F 29/83; B01F 33/82

(52) U.S. Cl. CPC E01C 19/1027; B01F 27/092; B01F 27/115; B01F 27/171; B01F 27/2124; B01F 29/82; B01F 29/83; B01F 33/823; B01F 2101/38; E01C 2019/1086

(57) ABSTRACT

The present invention provides a self-rotating asphalt emulsification mixing production apparatus, which relates to a technical field of construction engineering. It includes a rotatable inner tank, arranged in an outer tank, wherein the inner tank is provided with a blending shaft; a second blending blade, distributed on an outer wall of the inner tank; the emulsification tank is provided with a partition plate, an overfeed hole is provided at a center of the partition plate; a rotary shaft is provided at a center of the emulsification tank, and the rotary shaft is connected with the blending shaft through the overfeed hole; a first disk and a second disk are provided on the rotary shaft. The present invention can carry out more efficient mixing of the asphalt, better heating uniformity, and at the same time realize a integrated processing of the mixing and emulsification of asphalt and soap.

### TECHNICAL FIELD

The present invention relates to a technical field of construction engineering apparatus, more particular to a self-rotating asphalt emulsification mixing production apparatus.

### BACKGROUND TECHNOLOGY

Emulsified asphalt is oil-in-water or water-in-oil products generated by mixing the asphalt and a emulsified soap solution in proportion and then mechanical high-speed stirring them in order to make the asphalt to become fine particles dispersed in the emulsified soap solution. It is necessary for the existing asphalt emulsification processing to use multiple sets of processing equipment combined into a production line to achieve production, which not only costs high, but also occupies a large area. It will not be suitable for temporary emulsification processing of asphalt in the process of the construction operations.

Existing asphalt emulsification process is mainly completed in the emulsifier. The emulsifier includes a tank and a mixing device, a temperature control device, a heating device and others connected to a control system. The heating device can provide for the emulsifier continuous heat energy, and make the asphalt in the production of emulsification remain at a stable temperature with the aid of the temperature control device, and then the mixing device, etc., can mix the asphalt and the emulsified soap solution in the tank for the manipulating and finishing the the asphalt emulsification process. Before the actual emulsification, it is necessary to heat the asphalt to a certain temperature to make the asphalt hot melt into liquid and maintain the asphalt at a high temperature state before the asphalt emulsification process, in order to avoid too low temperature resulting in too large asphalt viscosity and difficult to flow and so on to affect the quality of emulsified asphalt. In order to improve production and working efficiency, reduce the time waiting for asphalt melting, it is typical in the emulsification process to continually use high temperature to keep heating the asphalt to be used to maintain it in a liquid state, and then ensure that when the emulsifier completes an emulsification operation, there are enough asphalt to be added to the emulsifier immediately to carry out another emulsification operation. This will consume a lot of energy for heating the asphalt under high temperatures, increasing the cost of preparation; at the same time, the asphalt will produce a lot of asphalt fumes under the prolonged high-temperature heating state and is very easy to aging, resulting in environmental pollution and degradation of the use performance.

The present applicant has filed an invention patent application with a patent number of CN201910858200.3 on Sep. 11, 2019. It discloses an asphalt emulsification mixing and production apparatus, which comprises a shell. A lower end of the shell is provided with a support foot and a discharge pipe, the discharge pipe is provided with a discharge valve, the shell is provided with a feed pipe, the feed pipe is provided with a feed valve, the shell is provided with a vertical inner tank and a mixing rod, the mixing rod is connected with a bearing seat on the inner wall of the shell, one end of the mixing rod passes through the shell and is connected with an output shaft of the motor, a main blending blade is arranged on the mixing rod; the upper and lower ends of the inner tank are open and the upper end of the inner tank is extended out of the upper end of the shell, a discharge valve is provided at the opening of the lower end of the inner tank, a rotatable screw is provided in the inner tank, the screw is connected to one end of a link rod through a connection bearing, and the other end of the link rod is provided on the inner wall of the inner tank. The invention is capable of reducing the amount of energy used to keep the asphalt in a liquid state.

Although the above patent solves the problem of energy usage, but only achieves the effect of simply mixing soap solution and asphalt, does not solve problems of the complexity, lower dispersion, low emulsification degree in the current emulsification asphalt process.

### SUMMARY OF THE DISCLOSURE

With respect to the above problems, the present invention provides a self-rotating asphalt emulsification mixing production apparatus, which are capable of more efficient stirring and mixing asphalt, with better heating uniformity, and at the same time realizing mixing and emulsification of the asphalt and the soap solution to be integrated in one process, and in comparison with the traditional asphalt emulsification processing, the apparatus in the present invention is small in size, low in energy consumption, and has a high degree of mixing the asphalt and the soap solution, and a better effect of emulsification.

In order to realize the above purpose, the technical solutions adopted in the present invention are:

A self-rotating asphalt emulsification mixing production apparatus includes a rotatable inner tank, arranged in an outer tank, wherein the inner tank is provided with a blending shaft, and a rotational direction of the blending shaft is opposite to that of the inner tank; a second blending blade, distributed on an outer wall of the inner tank; bottoms of the outer tank and the inner tank are connected to an emulsification tank through a valve switch; the emulsification tank is provided with a partition plate, an overfeed hole is provided at a center of the partition plate; a rotary shaft is provided at a center of the emulsification tank, and the rotary shaft is connected with the blending shaft through the overfeed hole; a first disk and a second disk are provided on the rotary shaft, wherein the first disk is located above the partition plate, and the second disk is located below the partition plate; a collision mixing mechanism is formed between the first disk and the partition plate; a grinding surface is formed between the second disk and the partition plate.

Compared with the prior art, the beneficial effects of the present invention are:

1. the inner tank rotates in the outer tank, related to the direction of rotation of the blending shaft, thus making speed of the relative rotation between the blending shaft and the inner tank faster, and improving the mixing effect of the asphalt, at the same time, the inner tank rotating in the soap solution can improve the uniformity of the distribution of the heat, since the asphalt is added to the inner tank, and the process of emulsification would need to heat up the liquid inside the tank, so that that part of the heat can be used to heat up the asphalt inside the inner tank, so that the asphalt in the inner tank maintain a liquid state; compared to the existing continuous high temperature to maintain asphalt in a liquid state, the use of heat from the emulsification equipment to keep asphalt in a liquid state is capable of reducing energy consumption, and avoids exhaust gas emission from the asphalt due to the continuous high-temperature heating, to achieve the purpose of energy saving.

2. the asphalt in the inner tank and the soap solution in the outer tank can flow directly into the emulsification tank at the lower end for mixing and emulsification, the first disk and the partition plate are cooperated and rotated, so that the asphalt and soap solution are forced to flow from the edge of the upper end surface of the partition plate to the overfeed holes, resulting in a counter-centrifugal mixing and grinding, so that the asphalt and soap solution achieve a highly efficient and uniformly mix and grind, and then the emulsified asphalt flows from the overfeed holes into a structure between the partition plate and the second disk, to perform a centrifugal grinding, so as to further increase the uniformity and purity of particles of the emulsified asphalt.

As a further improvement of the above technical solution, a first discharge hole is provided at a bottom of the inner tank; a second discharge hole is provided at a bottom of the outer tank; the valve switch comprises a first cover plate and a second cover plate which block the first discharge hole and the second discharge hole, respectively; the first cover plate is connected at its bottom to a fourth bracket by a support rod; the second cover plate is connected at its bottom to a third bracket by the support rod.

The beneficial effect of the above improvement is that the fourth bracket and the third bracket are used to control the lifting and lowering of the first cover plate and the second cover plate respectively, and the valve switch of a lifting structure is used to control the opening and closing of the first discharge hole and the second discharge hole.

As a further improvement of the above technical solutions, the third bracket is provided with a mounting ring in its center; the fourth bracket is provided with a perforation in its center; the third bracket is supported by the fourth bracket; and the rotary shaft is provided through the perforation; the rotary shaft is provided with a bracket ring for pushing the fourth bracket up and down; the rotary shaft is connected to a lifting-drive mechanism at its lower end.

The beneficial effect of the above improvement is: to further specify the control mechanism of the valve switch, when the rotary shaft is controlled to lift up and down through the lifting-drive mechanism, the third bracket and the fourth bracket are driven up and down at the same time through the bracket ring so as to synchronize the control of the opening and closing of the first discharge hole and the second discharge hole, and at the same time, it will not affect the fourth bracket and the rotary shaft to independently rotate each other.

As a further improvement of the above technical solutions, the lifting-drive mechanism is a telescopic rod connected to the lower end of the rotary shaft 18 via a rotary joint.

The beneficial effect of the above improvement is that the up and down elevation of the rotary shaft is driven by the telescopic rod, which does not affect the rotation of the rotary shaft because of the rotary joint.

As a further improvement of the aforesaid technical solution, the collision mixing mechanism comprises first arc-shaped strips distributed in an annular array on a bottom surface of the first disk, the first arc-shaped strips being separated into bumps by first annular groove distributed coaxially; second arc-shaped strips are distributed in an annular array on a top surface of the partition plate, the second arc-shaped strips are separated into bumps by second annular grooves distributed coaxially; the first arc-shaped strips and second arc-shaped strips are bent in opposite directions; the first annular grooves and second annular grooves are staggered with each other.

The beneficial effect of the above improvement is as follows: the asphalt and the soap solution come out from the bottoms of the inner tank and the outer tank respectively, and enter into the top of the first disk, and with the rotation of the first disk, the asphalt and the soap liquid are mixed under the action of centrifugal force and flow towards the edge, and then enter into the space between the first disk and the partition plate from the gap of the edge, and flow, mix and grind in the first arc-shaped strips and the first annular grooves, the second arc-shaped strips and the second annular grooves, and because the curvatures of the first arc-shaped strips and the second arc-shaped strips are opposite, so the asphalt and soap solution with the rotation of the first disk will be reversed to overcome the centrifugal force and flow toward the overfeed hole at the center of the partition plate, the flow process is subjected to centrifugal force and the extrusion pressure of the side walls of the annular groove at the same time and produces reciprocating collision movement, promotes the full mixing of asphalt and soap solution to become a state of oil-in-water or water-in-oil particles, improves the purity of the emulsified asphalt.

As a further improvement of the aforesaid technical solution, the second disk has fan-shaped convex strips distributed in an annular array on the top surface, the fan-shaped convex strips are separated into bumps by coaxially distributed third annular grooves; the partition plate has fan-shaped convex strips distributed in an annular array on the bottom surface, the fan-shaped convex strips are separated into bumps by coaxially distributed fourth annular grooves; the third annular grooves and the fourth annular grooves are set in a staggered manner with respect to each other.

The beneficial effect of the above improvement is: after the first emulsified asphalt enters the grinding surface between the partition plate and the second disk from the overfeed hole, it can centrifugally flow to the periphery more quickly under the rotation of the second disk to produce collision and grinding with greater kinetic energy to further improve the emulsification effect.

As a further improvement of the above technical solution, the upper end of the rotary shaft is connected to the blending shaft through a spline structure.

The beneficial effect of the above improvement is: the blending shaft drives the rotary shaft to rotate synchronously through the spline structure, and at the same time does not affect the up and down lifting movement of the rotary shaft itself.

As a further improvement of the above technical solution, a rotary blade is provided at the lower end of the blending shaft.

The beneficial effect of the above improvement is: the rotation of the rotary blade can prompt the asphalt in the inner tank to accelerate the flow of the asphalt from the outlet at the bottom of the inner tank, avoiding the flowing out of the asphalt to become intermittent and thus lead to uniform mixing of the asphalt and the soap solution.

As a further improvement of the above technical solution, a mounting bracket is provided in the emulsification tank; the lower end of the rotary shaft is rotatably provided on the mounting bracket.

The beneficial effect of the above improvement is that the lower end of the rotary shaft is limited by the mounting bracket to improve the operational stability of the rotary shaft.

As a further improvement of the above technical solution, the upper end of the blending shaft meshes with a transmission gear through a center gear; the transmission gear meshes with a toothed ring on the inner wall of the inner tank, which mutually constitute a planetary gear mechanism; a toothed ring on the outer wall of the inner tank meshes with a drive gear on a motor shaft with the motor.

The beneficial effect of the above improvement is: only one motor can drive the inner tank rotation at the same time, and can also drive the blending shaft at the center thereof rapid reverse rotation, the inner tank and the rotary shaft rotating in the opposite direction, resulting in the speed of relative rotation faster, and higher blending efficiency of the asphalt.

### BRIEF DESCRIPTION OF THE DRAWING

FIG. 1 shows a schematic diagram of a sectional structure of the present invention.

FIG. 2 is a schematic diagram of connection relationship of a driving mechanism of the present invention.

FIG. 3 is a schematic diagram of the structure when the valve switch in the emulsification tank is closed.

FIG. 4 is a schematic diagram of the structure when the valve switch inside the emulsification tank is open.

FIG. 5 is a top view of outlets at the bottoms of the inner and outer tanks.

FIG. 6 is a top view schematic diagram of a first cover connection structure in the valve switch.

FIG. 7 is a top view schematic diagram of a second cover plate connection structure in the valve switch.

FIG. 8 is a schematic diagram of a bottom surface structure of the first disk.

FIG. 9 is a schematic diagram of a top surface structure of the partition plate.

FIG. 10 is a schematic diagram of a structure of the bottom surface of the first disk and the top surface of the partition plate after cooperation.

FIG. 11 is a schematic diagram of the structure of the bottom surface of the partition plate.

FIG. 12 is a schematic diagram of the structure of the top surface of the second disk.

FIG. 13 shows a schematic diagram of the structure of the bottom surface of the partition plate after cooperating with the top surface of the second disk.

In the figure: 1 motor; 2 top plate of the apparatus; 3 drive gear; 4 transmission gear; 5 center gear; 6 first feeding port; 7 second feeding port; 8 inner tank; 9 second blending blade; 10 outer tank; 12 valve switch; 13 emulsification tank; 14 rotary blade; 15 first blending blade; 16 blending shaft; 17 spline hole; 18 rotary shaft; 19 bracket ring; 20 first discharge hole; 21 second discharge hole; 22 first disk; 23 partition plate; 24 second disk; 25 overfeed hole; 26 mounting bracket; 27 electromagnet; 28 magnetic conductor block; 29 first arc-shaped strip; 30 first annular groove; 31, second arc-shaped strip; 32 second annular groove; 33 third annular groove; 34 fan-shaped convex strip; 35 fourth annular groove; 121 perforation; 122 third bracket; 123 support rod; 124 second cover; 125 first cover; 126 fourth bracket; 127 mounting ring; 201 first bracket; 211 second bracket.

### DETAILED DESCRIPTION OF THE PREFERRED EMBODIMENT

In order to enable those skilled in the art to better understand the technical solution of the present invention, the present invention is described in detail in the following in conjunction with the accompanying drawings, and the present description is only exemplary and explanatory, and should not have any limiting effect on the scope of protection of the present invention.

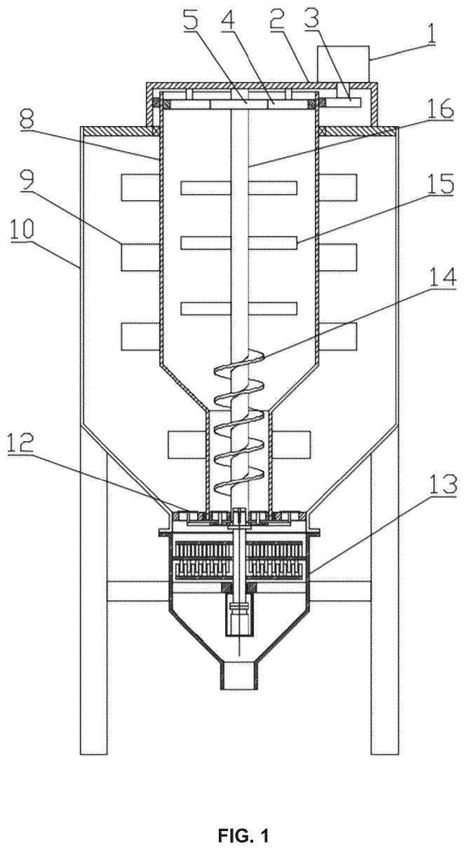

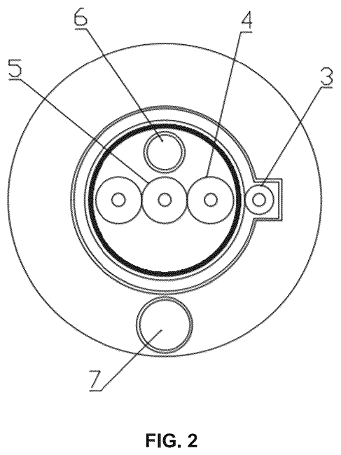

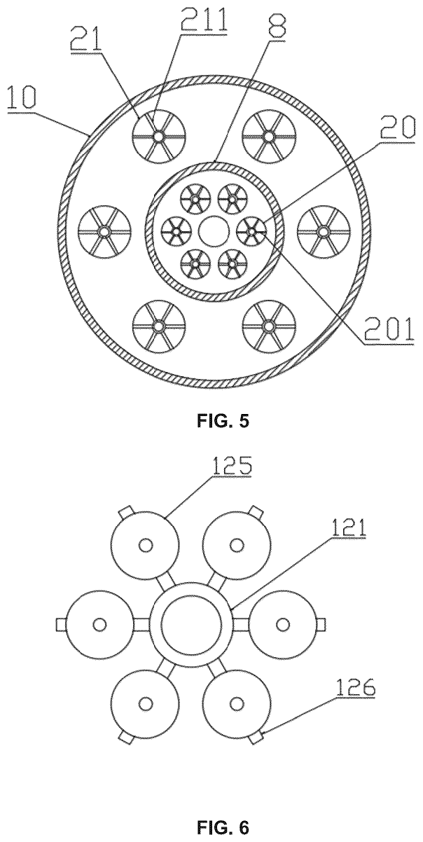

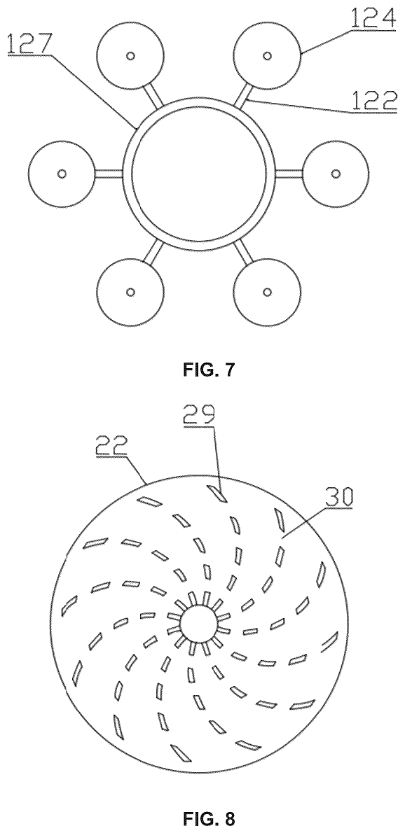

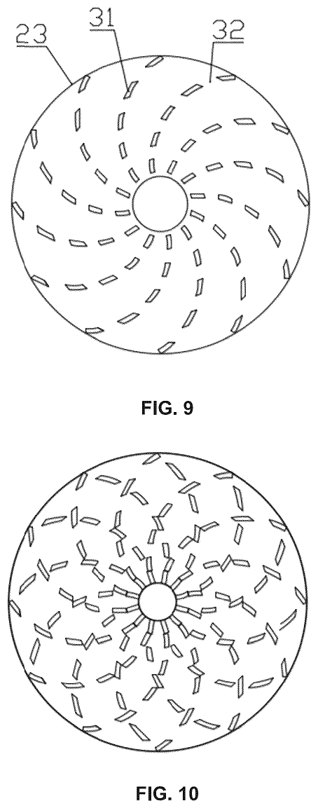

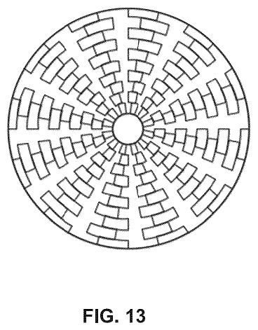

Referring to FIGS. 1 to 13, in a specific embodiment, a self-rotating asphalt emulsification mixing production apparatus, includes a rotatable inner tank 8, arranged in an outer tank 10, wherein the inner tank 8 is provided with a blending shaft 16, and a rotational direction of the blending shaft 16 is opposite to that of the inner tank 8; a second blending blade 9, distributed on an outer wall of the inner tank 8; bottoms of the outer tank 10 and the inner tank 8 are connected to an emulsification tank 13 through a valve switch 12; the emulsification tank 13 is provided with a partition plate 23, an overfeed hole 25 is provided at a center of the partition plate 23; a rotary shaft 18 is provided at a center of the emulsification tank 13, and the rotary shaft 18 is connected with the blending shaft 16 through the overfeed hole 25; a first disk 22 and a second disk 24 are provided on the rotary shaft 18, wherein the first disk 22 is located above the partition plate 23, and the second disk 24 is located below the partition plate 23; a collision mixing mechanism is formed between the first disk 22 and the partition plate 23; a grinding surface is formed between the second disk 22 and the partition plate 23.

The lower end of the outer tank 10 is conical, the lower end of the inner tank 8 is also conical, the rotating member 11 can be cylinder or ring-shaped, mounted on the outer wall of the inner tank 8 through the bearings; an emulsification tank 13 is cylinder, the lower end thereof is conical; the outer walls at the upper end of the emulsification tank are connected to the outer tank 10 with bolted connection through the flange edge; the aperture of the overfeed hole 25 is larger than that of the rotary shaft 18, so that it is easy for the emulsified asphalt from the overfeed hole 25 to fall, due to the rotation of the rotary shaft 18 inside of the overfeed hole 25, the rotary shaft 18 can play a role of the uniform distribution of the emulsified asphalt, so that the emulsified asphalt can be rotated with the rotary shaft 18 and pass through the overfeed hole 25 to flow down to improve the uniformity of distribution; the first disk 22 and the second disk 24 are fixedly connected with the rotary shaft 18. The bottom surface of the first disk 22 and the upper end surface of the partition plate 23 have mutually cooperated bumps, and the counter-centrifugal rotary grinding is carried out by the mutually cooperated bumps, to realize the mixing and grinding of the asphalt and the soap solution, to complete the first emulsification process. And then the emulsified asphalt flows from the overfeed hole 25 to fall into the grinding surface between the bottom surface of the partition plate and the upper end surface of the second disk 24, and the centrifugal grinding is once again carried out by the mutually cooperated bumps to complete the second emulsification, finally making the emulsified asphalt have smaller and more uniform particles.

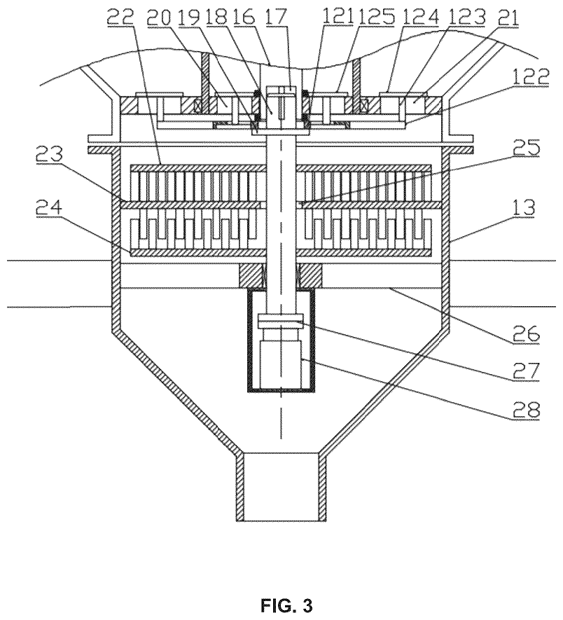

Further optimized on the basis of the above embodiment, as shown in FIGS. 3-7, the inner tank 8 is provided with a first discharge hole 20 at the bottom; the outer tank 10 is provided with a second discharge hole 21 at the bottom; the valve switch 12 comprises a first cover 125 and a second cover 124 blocking the first discharge hole 20 and the second discharge hole 21, respectively; a bottom of the first cover 125 is connected to a fourth bracket 126 by means of a support rod 123; a bottom of the second cover 124 is connected to a third bracket 122 by means of the support rod 123.

A first bracket 201 may be added in the first discharge hole 20, and a second bracket 211 may be added in the second discharge hole 21; the support rod 123 is radially limited by the bracket to improve the lifting and lowering stability of the cover; the diameter of the first cover 125 is larger than the aperture of the first discharge hole 20; and the diameter of the second cover 124 is larger than the aperture of the second discharge hole 21.

Further optimized on the basis of the above embodiment, as shown in FIGS. 3-7, the third bracket 122 is provided with a mounting ring 127 at the center; the fourth bracket 126 is provided with a perforation 121 at the center; the third bracket 122 is supported by the fourth bracket 126; the rotary shaft 18 is provided through the perforation 121; the rotary shaft 18 is provided with a bracket ring 19 for driving the lifting and lowering of the fourth bracket 126; and the rotary shaft 18 is connected to a lifting and lowering drive mechanism at the lower end.

Further optimized on the basis of the above embodiment, the lifting and lowering drive mechanism is a lifting rod 28 connected to the lower end of the rotary shaft 18 via a rotary joint 27; the lifting rod 28 is a cylinder or a hydraulic cylinder or an electric actuator rod.

Further optimized on the basis of the above embodiment, as shown in FIGS. 8-10, the collision mixing mechanism includes first arc-shaped strips 30 distributed in an annular array on the bottom surface of the first disk, the first arc-shaped strips 30 are separated into bumps by coaxially distributed first annular grooves 29; the partition plate 23 has second arc-shaped strips 31 distributed in an annular array on the top surface of the partition plate 23, the second arc-shaped strips 31 are separated into bumps by coaxially distributed second annular grooves 32; the first arc-shaped strips 30 and the second arc-shaped strips 31 are curved in opposite directions; and the first annular grooves 29 and the second annular grooves 32 are staggered with each other.

The first arc-shaped strips 30 and the second arc-shaped strips 31 are of arc-shaped convex bump shape, the first arc-shaped strip 30 is at one end toward the center of the first disk 22, and at the other end toward the edge of the first disk 22; the second arc-shaped strip 31 is at one end toward the center of the partition plate 23, and at the other end toward the edge of the partition plate 23; the bumps on the bottom surface of the first disk 22 protrude into the second annular groove 32, while the bumps on the top surface of the partition plate 23 protrude and extend into the first annular grooves 29; they are nested in each other to form a colloidal grinding structure; during operation, the asphalt and the soap solution fall on the top surface of the partition plate 23, and then the rotary shaft drives the first disk 22 to rotate, so that the bumps on the first disk 22 push the asphalt and the soap solution toward the center to be ground;

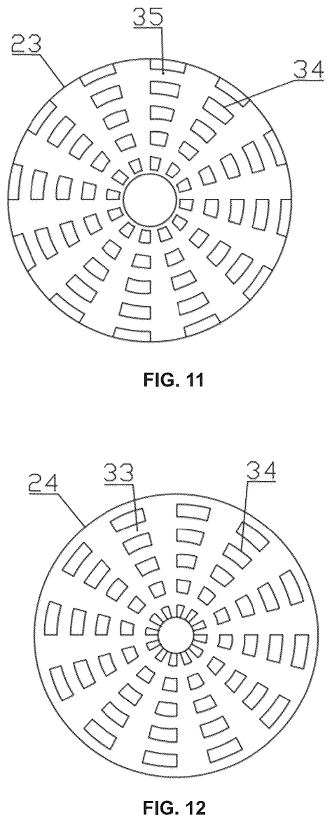

Further optimized on the basis of the above embodiment, as shown in FIGS. 11-13, the second disk 24 has fan-shaped convex strips 34 distributed in an annular array on the top surface, the fan-shaped convex strips 34 being separated into bumps by coaxially distributed third annular grooves 33; the partition plate 23 has fan-shaped convex strips 34 distributed in an annular array on the bottom surface, the fan-shaped convex strips 34 being separated into bumps by coaxially distributed fourth annular grooves 35; and the third annular grooves 33 and fourth annular grooves 35 are staggered to each other.

The fan-shaped convex strips 34 has one end facing the center of the second disk 24 and the other end facing the edge of the second disk 24, and all the fan-shaped convex strips 34 are dispersed and radiated in a distribution with the center of the second disk 24 as the origin; similarly, the fan-shaped convex strips 34 on the partition plate 23 also have one end facing the center of the partition plate 23 and the other end facing the edge of the partition plate 23, and all the fan-shaped convex strips are dispersed and radiated in a distribution with the center of the partition plate 23 as the origin; the top surface of the second disk 24 and the bottom surface of the partition plate 23 are nested with each other to form a colloidal grinding structure; the bumps protruding from the top surface of the second disk 24 are inserted into the corresponding fourth annular grooves 35 on the bottom surface of the partition plate 23; and the bumps protruding from the bottom surface of the partition plate 23 are inserted into the third annular grooves 33 on the top surface of the second disk 24.

Further optimized on the basis of the above embodiment, the upper end of the rotary shaft 18 is connected to the blending shaft 16 via a spline structure.

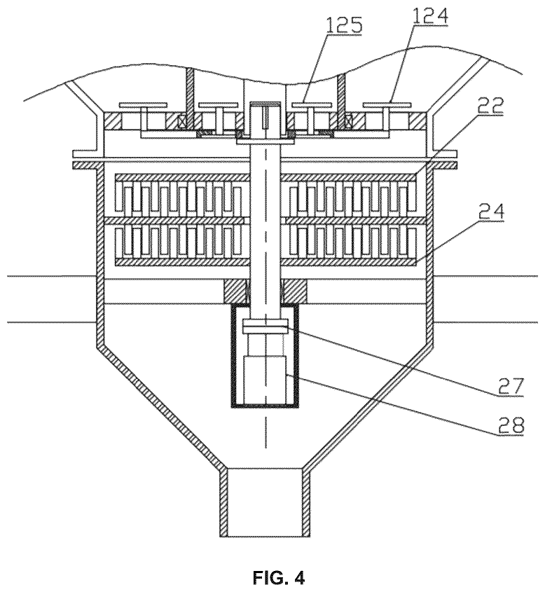

As shown in FIGS. 3-4, the side wall of the upper end of the rotary shaft 18 is distributed with spline projections of straight strip shapes; and the spline hole 17 at the lower end of the blending shaft 16 is distributed with grooves that are fitted with the spline projections; thereby allowing the rotary shaft 18 to rotate synchronously with the rotation of the blending shaft 16, but in turn ensuring that the rotary shaft 18 can freely elevate and move up and down.

Further optimized on the basis of the above embodiment, the blending shaft 16 is provided with rotary blades 14 at the lower end.

As shown in FIG. 1, the asphalt can be made to have a downward squeezing force by rotating the blades 14, thereby ensuring that the asphalt can be discharged more quickly from the first discharge hole 20.

Further optimized on the basis of the above embodiment, the upper end of the blending shaft 16 meshes with a transmission gear 4 via a central gear 5; the transmission gear 4 meshes with a toothed ring on the inner wall of the inner tank 8, mutually constituting a planetary gear mechanism; the toothed ring on the outer wall of the inner tank 8 meshes with a drive gear 3 on the motor shaft with the electric motor 1.

The center gear 5 and the transmission gear 4 and the electric motor 1 are mounted on the top plate 2 of the apparatus, and the upper end of the inner tank is connected to the top plate 2 of the apparatus by a bearing.

Further optimized on the basis of the above embodiment, the emulsification tank 13 is provided with a mounting bracket 26; the lower end of the rotary shaft 18 is rotatably provided on the mounting bracket 26. The mounting bracket 26 is mounted at the lower end of the emulsification tank 13.

The specific working principle of the present invention is as follows:

As shown in FIG. 1, the asphalt in a liquid form is introduced into the inner tank 8 through the first feeding port 6, and the soap solution is introduced into the outer tank 10 through the second feeding port 7, the motor 1 drives the inner tank to rotate through the drive gear 3, and the toothed ring on the inner wall of the inner tank drives the transmission gear 4 to rotate, and the transmission gear 4 then drives the center gear 5 to rotate, forming a planetary gear mechanism, thus driving the blending shaft 16 to rotate, and a relative rotation is formed between the blending shaft 16 and inner tank, thereby improving the blending of the asphalt inside the inner tank 8 by the first blending blade 15; at the same time, while the inner tank is rotating, the second blending blade 9 on the outer wall thereof blends the soap solution, and since the inner tank can rotate inside the soap solution, the uniformity of heat transmission between the asphalt and the soap solution inside the inner tank can be improved.

As shown in FIGS. 3-4, the electromagnet 27 is energized, driving the rotary shaft 18 upward, and the bracket ring 19 on the rotary shaft 18 pushes the fourth bracket 126 and the third bracket 122 upwardly to lift up and down, thereby opening the first cover 125 and the second cover 124; the asphalt and the soap solution flow out of the first discharge hole 20 and the second discharge hole 21, respectively, and enter into the emulsification tank 13;
the asphalt and soap entered the emulsification tank 13 firstly fall on the upper end surface of the first disk 22, with the rotation of the first disk 22, the asphalt and soap solution will be thrown to the edge thereof and flow to the upper end surface of the partition plate 23, the bumps are distributed on the bottom surface of the first disk 22, these bumps are separated by the first arc-shaped strips 30 and the first annular grooves 29; when the first disk 22 rotates, these bumps will generate a pushing effect to the center and making the grinding at the same time, so that the asphalt and soap solution are mixed and flow to the overfeed hole 25 at the center of the partition plate 23, and the bumps on the first disk 22 and the bumps on the end surface of the partition plate cooperate with each other and rotated relative to each other, thereby forming the separation, the soap solution and the are subject to the pushing effect to the center from the bumps, and at the same time are subjected to a certain amount of centrifugal force, so that the soap solution and the asphalt reciprocate along the radial direction and continuously grind, rapidly mix and uniformly emulsify, and flow out from the overfeed hole 25;
the emulsified asphalt flowing out from the overfeed hole 25 falls onto the second disk 24, and with the rotation of the second disk 24, the emulsified asphalt is subjected to a greater centrifugal force effect to flow outwardly, so as to be further emulsified and processed through the relative rotational separation of the second disk 24 and the bumps on the bottom surface of the partition plate, and ultimately, the fully emulsified asphalt is flung out from the edge of the second disk 24, and out of the lower port of the emulsification tank 13.

When the electromagnet 27 is powered off, the rotary shaft 18 descends under gravity, and at the same time the bracket 122 also descends under gravity, and the first cover plate and the second cover plate block the first discharge hole 20 and the second discharge hole 21, respectively.

It should be noted that, as used herein, the terms “including”, “comprising”, or any other variant thereof, are intended to cover non-exclusive inclusion, such that a process, method, article, or apparatus that comprises a set of elements comprises not only those elements but also other elements that are not explicitly listed, or that are inherent to such a process, method, article or apparatus.

Specific examples are used herein to illustrate the principles and embodiments of the present invention, and the illustrations of the above examples are only intended to assist in understanding the method of the present invention and its core ideas. The foregoing is only a preferred embodiment of the present invention, and it should be noted that, due to the textual expression being finite and the objective existence of an infinite number of specific structures, for a person of ordinary skilled in the art, without departing from the principles of the present invention, a number of improvements, embellishments, or variations can be made, and also combinations of the foregoing technical features can be made in an appropriate manner; these improvements embellishments, variations, or combinations, or the direct application of the inventive concept and technical solution to other occasions without improvement, shall be regarded as the scope of protection of the present invention.

What claim is:

1. A self-rotating asphalt emulsification mixing production apparatus, characterized in that, it comprises:
a rotatable inner tank (8), arranged in an outer tank (10), wherein the inner tank (8) is provided with a blending shaft (16), and a rotational direction of the blending shaft (16) is opposite to that of the inner tank (8);
a second blending blade (9), distributed on an outer wall of the inner tank (8);
bottoms of the outer tank (10) and the inner tank (8) are connected to an emulsification tank (13) through a valve switch (12);
the emulsification tank (13) is provided with a partition plate (23), an overfeed hole (25) is provided at a center of the partition plate (23);
a rotary shaft (18) is provided at a center of the emulsification tank (13), and the rotary shaft (18) is connected with the blending shaft (16) through the overfeed hole (25);
a first disk and a second disk are provided on the rotary shaft (18), wherein the first disk (22) is located above the partition plate (23), and the second disk (24) is located below the partition plate (23);
a collision mixing mechanism is formed between the first disk (22) and the partition plate (23); a grinding surface is formed between the second disk (22) and the partition plate (23).

2. The self-rotating asphalt emulsification mixing production apparatus according to claim 1, characterized in that,
a first discharge hole (20) is provided at a bottom of the inner tank (8); a second discharge hole (21) is provided at a bottom of the outer tank (10); the valve switch (12) comprises a first cover plate (125) and a second cover plate (124) which block the first discharge hole (20) and the second discharge hole (21), respectively;
the first cover plate (125) is connected at its bottom to a fourth bracket (126) by a support rod (123); the second cover plate (124) is connected at its bottom to a third bracket (122) by the support rod (123).

3. The self-rotating asphalt emulsification mixing production apparatus according to claim 2, characterized in that,
the third bracket (122) is provided with a mounting ring (127) in its center; the fourth bracket (126) is provided with a perforation (121) in its center;
the third bracket (122) is supported by the fourth bracket (126); and the rotary shaft (18) is provided through the perforation (121); the rotary shaft (18) is provided with a bracket ring (19) for pushing the fourth bracket (126) up and down; the rotary shaft (18) is connected to a lifting-drive mechanism at its lower end.

4. The self-rotating asphalt emulsification mixing production apparatus according to claim 3, characterized in that,
the lifting-drive mechanism is a telescopic rod (28) connected to the lower end of the rotary shaft (18) via a rotary joint (27).

5. The self-rotating asphalt emulsification mixing production apparatus according to claim 1, characterized in that,
the collision mixing mechanism comprises first arc-shaped strips (30) distributed in an annular array on a bottom surface of the first disk (22), the first arc-shaped strips (30) being separated into bumps by first annular groove (29) distributed coaxially; second arc-shaped strips (31) are distributed in an annular array on a top surface of the partition plate (23), the second arc-shaped strips (31) are separated into bumps by second annular grooves (32) distributed coaxially; the first arc-shaped strips (30) and second arc-shaped strips (31) are bent in opposite directions; the first annular grooves (29) and second annular grooves (32) are staggered with each other.

6. The self-rotating asphalt emulsification mixing production apparatus according to claim 1, characterized in that,
fan-shaped convex strips (34) are distributed in an annular array on a top surface of the second disk (24), the fan-shaped convex strips (34) are separated into bumps by third annular grooves (33) distributed coaxially;
fan-shaped convex strips (34) are distributed in an annular array on a bottom surface of the partition plate (23), the fan-shaped convex strips (34) are separated into bumps by fourth annular grooves (35) distributed coaxially; and the third annular groove (33) and the fourth annular groove (35) are staggered with each other.

7. The self-rotating asphalt emulsification mixing production apparatus according to claim 1, characterized in that,
the upper end of the rotating shaft (18) is connected to the blending shaft (16) through a spline structure.

8. The self-rotating asphalt emulsification mixing production apparatus according to claim 1, characterized in that,
a rotary blade (14) is provided at the lower end of the blending shaft (16).

9. The self-rotating asphalt emulsification mixing production apparatus according to claim 1, characterized in that,
the upper end of the blending shaft (16) is meshed with a transmission gear (4) through a central gear (5); the transmission gear (4) meshes with a toothed ring on the inner wall of the inner tank (8), which mutually constitute a planetary gear mechanism; and
a toothed ring on the outer wall of the inner tank (8) meshes with a drive gear (3) on a motor shaft with the motor (1).

10. The self-rotating asphalt emulsification mixing production apparatus according to claim 1, characterized in that,
the emulsification tank (13) is provided with a mounting bracket (26); and the lower end of the rotating shaft (18) is moveablly provided on the mounting bracket (26).
